(19) United States
(12) Patent Application Publication
(10) Pub. No.: US 2008/0183571 A1
(43) Pub. Date: Jul. 31, 2008

(54) METHODS AND SYSTEMS FOR PROVISIONING AND USING AN ELECTRONIC COUPON

(76) Inventor: Jeffrey Aaron, Atlanta, GA (US)

Correspondence Address: WITHERS & KEYS FOR BELL SOUTH, P. O. BOX 71355, MARIETTA, GA, 30007-1355, US

(21) Appl. No.: 11/668,848

(22) Filed: Jan. 30, 2007

(51) Int. Cl. G06Q 30/00

(52) U.S. Cl. 705/14

(57) ABSTRACT

Provided are methods and devices for the provision and use of an electronic coupon which includes receiving an electronic file at a mobile communication device. The electronic file includes a data string unique to a user of the mobile communication device and is also associated with a vendor location. The electronic file is received from a server via a network based upon a current geographic position of the mobile communication device. The electronic file identifies a shopping location and includes a data string that is unique to a user of the mobile communication device. The method further includes providing the electronic file to an intermediary computing device associated with the location. The intermediary computing device may be of a merchant where the data string is analyzed to provide a discount to the user of the mobile device.

### TECHNICAL FIELD

Embodiments are related to mobile communication devices. More particularly, embodiments described herein relate to a systems and methods for allowing a user of a wireless communication device to receive and utilize an electronic coupon with their wireless communication device.

### BACKGROUND

Just about everyone loves a bargain and vendors have relied on the issuance of paper coupons for at least a century as a way to present their best customers with a “special” discounted price. The customers win by keeping some extra money in their pockets and the vendor wins by reinforcing customer relations and maybe generating an incremental boost to sales volume. The cost of the coupon usually is paid by the manufacturer.

However, there is a significant cost to issue a coupon. Paper and printing services cost money. In addition, most printed coupons go to waste when uninterested recipients discard coupons or the coupons expire due to customer forgetfulness. Further, many people shy away from using coupons because they consider using coupons boring and/or requiring too much extra effort and/or old fashioned, such that a way to make coupons easier, fun, and exciting would be quite beneficial.

### SUMMARY

Wireless communication devices are popular and ubiquitous devices amongst the general populace. The cost of wireless communication devices has plummeted and functionality has improved exponentially. Most adults and an increasing number of children routinely carry a cell phone or other wireless communication device on their person. While energized, wireless communication devices are continuously vigilant, scanning a frequency for an indication of an incoming call. The omnipresence, vigilance and computing power of a wireless communication device can be leveraged to provide an instantaneous and paperless method for provisioning an electronic coupon to a targeted customer. Further, a wireless communication device may provide techniques for using coupons not possible with the current paper coupons. It should be appreciated that this Summary is provided to introduce a selection of these concepts in a simplified form that are further described below in the Detailed Description. This Summary is not intended to identify key features or essential features of the claimed subject matter, nor is it intended to be used to limit the scope of the claimed subject matter.

Provided are exemplary embodiments. The embodiments provide a method for the provision and use of an electronic coupon which includes receiving an electronic file at a mobile communication device. The electronic file is received from a server via a network and is based at least in part upon a current geographic position of the mobile communication device. The electronic file identifies a shopping location and includes a data string that is unique to a user of the mobile communication device. The method further includes providing the electronic file to an intermediary computing device associated with the location. The intermediary computing device may be that of a merchant where the data string is analyzed to provide a discount to the user of the mobile device.

Exemplary embodiments also include a device communicating within a network for the provision and use of an electronic coupon that includes a transceiver, a position/location determination device, and a processor. The processor sends geographic data to a server within the network via the transceiver and receives an electronic coupon file in response, the processor receives the geographic data from a position determination device and auto-transmits the data to the server, wherein the geographic data includes a current geographic position of the mobile communication device and the electronic coupon file includes a data string unique to a user of the mobile communication device and also associated with a vendor location.

In accordance with other exemplary embodiments, a server is provided comprising a network interface and a processor. The processor receives geographical data from a wireless communication device and returns an electronic data string to the wireless device. The geographical data includes a current geographical position of the wireless communication device. The electronic data string returned is unique to a user of the wireless communication device and is also associated with a vendor location.

Other apparatuses, methods, and/or computer program products according to embodiments will be or become apparent to one with skill in the art upon review of the following drawings and Detailed Description. It is intended that all such additional systems, methods, and/or computer program products be included within this description, be within the scope of the present invention, and be protected by the accompanying claims.

### BRIEF DESCRIPTION OF THE DRAWINGS

FIG. 1 is an overview illustrating a system for provisioning and using an electronic coupon utilizing a wireless communication device.

FIG. 2 depicts an example of a wireless communication device configured to receive and utilize an electronic coupon.

FIG. 3 depicts a network server capable of coordinating the provisioning and use of electronic coupons.

FIG. 4 is an exemplary flow chart demonstrating the process of creating an electronic coupon with a wireless communication device.

FIG. 5 is an exemplary flow chart demonstrating a method for combining electronic data strings with a wireless communication device.

FIG. 6 is an exemplary flow chart demonstrating the creation and delivery of an electronic data string to a wireless communication device.

FIG. 7 is an exemplary flow chart demonstrating the processing of an electronic coupon after being honored.

### DETAILED DESCRIPTION

The following disclosure is directed to apparatus and methods for allowing a user of a mobile or a wireless communication device (“WCD”) to receive, combine and use an electronic coupon. A WCD may be any wireless communication device. Non-limiting examples may include a cell phone, a PDA, a pager, a VoIP phone, a dual mode phone an MP3 player, a miniaturized computer and the like.

The use of the WCDs has grown exponentially over the last decade. Today, most adults and an increasing number of children carry a WCD of some type or another. The most common WCD is the ubiquitous cell phone. However, there are millions of devotees to pagers, personal digital assistants (“PDA”) and other mobile devices. Technologies are also merging. For example MP3 players may be incorporated into cell phones and vice versa. Whatever the device, users of the WCDs depend upon them to keep them connected to business, family and friends in an increasingly hectic world.

Our society today is built on and structured around commerce, the buying and selling of merchandise on a large scale. Commerce, in turn requires a merchant to be able to communicate with his customer base concerning the availability and price of his merchandise. For decades, one of the most popular means of communication between a vendor and his customer base has been by issuing paper coupons that entitles the customer to a discount from the usual price charged to the general populace. Customers like coupons because they save money. Vendors like coupons because they drive sales volume higher and they usually do not finance the cost of the discount. The discount is usually covered by a third party such as the manufacturer.

Although popular, there is an overhead cost to issuing coupons. There is the cost of the paper, printing, distribution and of course waste. Only a small fraction of coupons printed are honored by the vendor. Most are discarded or expire under their own terms before they are used. The cost of a coupon issuance may be reduced and the effectiveness increased by using a mobile communication device, such as a cell phone, to issue and redeem the coupon. The coupon may also be targeted with precision to those cell phone users who may have a particular interest in a particular type of merchandise and who may be near a particular vendor.

An omnipresent, inexpensive and user friendly means to distribute and use coupons has not previously existed. To address these issues, a WCD may be configured to detect and report the user's geographic position. The geographic position may be communicated to a server within a communication network where the geographic coordinates are compared to a database of coupon issuing vendors. The system may allow the server to then issue a coupon that is redeemable by a vendor in the immediate vicinity of the user of the wireless communication device. Because the user may have recorded personal preferences, the electronic coupons may be associated with merchandise that may be of particular interest to the user as well. The detection of the WCDs presence and the issuance of the electronic coupon are done in real time or near-real time. The terms “real time” and “near-real time” are used herein to mean immediately or “in the moment”. If so configured, a WCD may be able to automatically provide information about its current location and receive a coupon as a user approaches to within a specific distance of the vendor location or it may be retrieved upon request.

In the following detailed description, references are made to the accompanying drawings that form a part hereof and which are shown, by way of illustration, using specific embodiments or examples. Referring now to the drawings, in which like numerals represent like elements through the several figures, aspects of the apparatus and methods provided herein will be described.

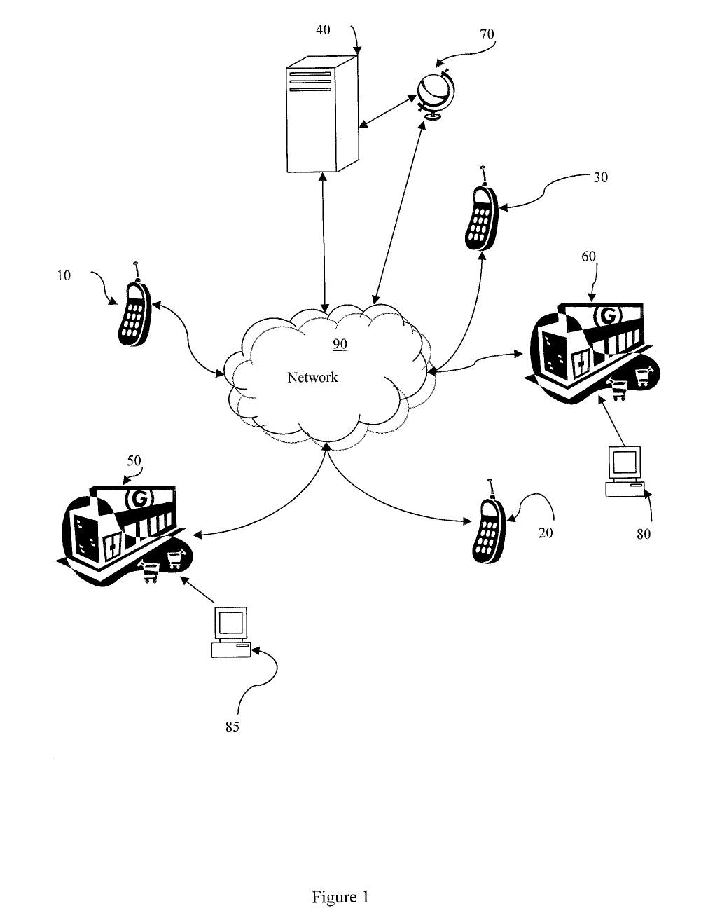

FIG. 1 is an overview of an exemplary system consistent with embodiments described herein. A WCD such as WCDs 10, 20 and 30 may be any type of wireless communication device. As a further example, the WCD 10 may be a conventional lap top computer with wireless capability. The WCD 10 may also include software objects to configure the WCD 10 with Global Positioning System (“GPS”) capability or, in the alternative, cellular triangulation capability.

The WCD 10 may be capable of long range communication with a telecommunications network 90. The telecommunications network 90 may be any telecommunications network including a mobile telecommunications network where the user may travel from base station-to-base station or hot spot-to-hot spot. The telecommunications network 90 may be an analog or digital cellular telecommunications network. Moreover, the telecommunications network 90 may be a Personal Communication Service (PCS) in either of its analog and digital versions. The telecommunication network 90 may utilize Time Division Multiple Access (TDMA), Code Division Multiple Access (CDMA), Frequency Division Multiple Access (FDMA) or Global System for Mobile (GSM) technologies. The telecommunications network 90 may also be a satellite communication system or employ multiple connected instances of short-range communications such as WiFi and/or city wide communications such as WiMax and still fall under the purview of this disclosure. Other suitable communications systems may also be used.

Telecommunication network 90 may include a central server 40 and/or a Geographic Information System (“GIS”) 70. According to exemplary embodiments, the GIS 70 is a centralized database system containing detailed cartographic and aerial photography information that may be used to augment GPS data as discussed further herein. The central server 40 may store associated information on a plurality of vendor locations. Central server 40 may be a single server or multiple interconnected servers and mass storage devices disbursed within the network 90. The Network 90 may include a plurality of the WCDs 10, 20 and 30.

In FIG. 1, locations 50 and 60 are illustrative examples of vendor locations. The actual number of participating vendors is limited only by the available storage capacity in the network 90. The central server 40 may also store a plurality of customer or shopper preference profiles for a plurality of customers. FIG. 1 illustrates the WCDs 10, 20 and 30 as illustrative examples of WCDs associated with each of the plurality of customers. The actual number of participating customers is limited only by the available storage capacity in the network.

According to exemplary embodiments, the WCD, such as WCD 10 is associated with an electronic coupon feature. When the coupon feature is turned on by the user, the WCD 10 may begin to periodically determine its position and auto transmit its position to server 40 via the network 90. The coupon feature may be selected by selecting or toggling a switch associated with the WCD 10, a key or set of keys associated with the WCD or by manipulating a touch screen associated with the WCD as is desired to meet a specific purpose. The coupon feature may be remotely selected by the server 40 or it may be selectable by both the user and the server 40.

The WCD 10 may determine its position by utilizing a GPS signal if the WCD is so configured. In the alternative, the WCD 10 may also determine its position using cellular triangulation or some other radio triangulation technique and/or other location determining method. The WCD 10 may be configured to use multiple types of techniques to determine the WCD's position. The central server 40 may also be capable of determining the position of the WCD 10 by cellular triangulation or other means should a system design so require. Determining the geographic position of the WCD 10 at the central server 40 would relieve the WCD 10 of that computing and power requirement. Ancillary data concerning a reported geographic position may be provided by the GIS 70. The GIS 70 may provide detailed data concerning the various structures at a location or be able to clarify otherwise ambiguous situations.

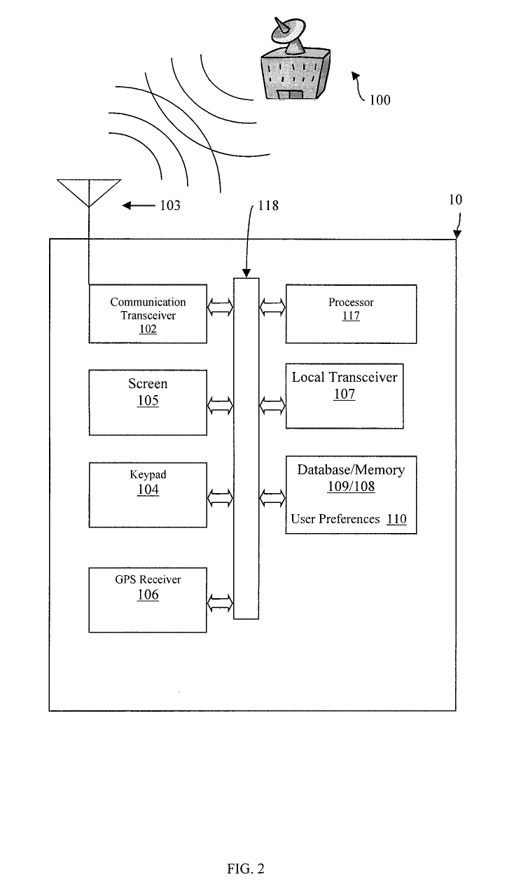

In addition, the user of the WCD 10 may enter his geographic position manually. As a non-limiting example, the user of the WCD 10 may enter a name or local map coordinates using a keypad 104 or a touch screen 105 (See FIG. 2). The manual entry may be then used by the central server 40 to select suitable locations as if the position of the WCD 10 was reported automatically. If local map coordinates are used, the GIS 70 may assist in converting the local map coordinates to a geographic position using coordinates compatible with telecommunications network 90 such as latitude and longitude, for example.

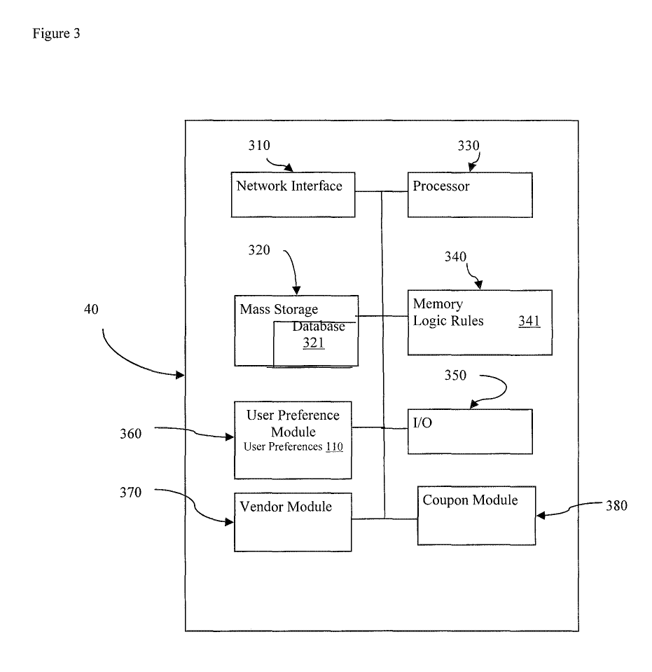

Continuing with the illustrative example, vendor locations 50 and 60 may be two retail stores in a strip mall which have contracted with an electronic coupon service according to embodiments described herein. As the user of the WCD 10 arrives at the strip mall parking lot, the WCD 10 may transmit a periodic position report to the server 40, via network interface 310 (See FIG. 3). The server 40 may then look up the geographic position of the WCD 10 in a database 321. The database 321 may include all of the subscribing vendors that have subscribed to the electronic coupon service to determine vendor locations, such as vendor locations 50 and 60, within a specified radius of the geographic position of the WCD 10.

The server 40 may contain a set of logic rules 341 to clarify and more accurately select the vendor locations that may be returned from the database 321. As a non-limiting example, the server 40 or GIS 70 may know that the parking lot at which the user of the WCD 10 is located belongs only to that particular strip mall and that the parking lot has certain dimensions. The logic rules 341 may filter the vendor location search results to only those vendor locations that are within a certain distance and in a certain direction from the customer's parking lot location. As such, the logic rules 341 may fine tune the list of the vendor locations 50 and 60. Another screening technique may have the vendor locations directly associated with the geographic area of the parking lot so that other locations in a competing, adjacent strip mall will not be associated with the parking lot area and therefore not pass the screen and not be displayed to the user of the WCD 10. Examples of the logic rules 341 are myriad and other logic rules may occur to those of ordinary skill in the art to accomplish a specific goal.

Once a list of the relevant vendor locations 50/60 is determined, the central server 40 may download any electronic coupons that the vendor(s) associated with the relevant vendor locations may have authorized for distribution. Participating vendors may authorize electronic coupon distribution by accessing the central server 40 through the network interface 310. The interface 310 may be any kind of interface. Non-limiting examples may include a web page or an interactive telephone line.

Conventional paper coupons usually contain an image or a description of an item of merchandise and an indication of value. The value may be an actual price, free merchandise or an indication of a percentage discount from the regular price. A paper coupon may also include information concerning the genre or type of coupon that is being issued so that the vendor can account for the discounts and track inventory. Electronic coupons may have similar features. Electronic coupons may display text or graphics or both on a user interface such as a cell phone screen. Electronic coupons may also produce sound. The data and graphics are useful to describe to the user who is honoring the coupon, what the merchandise may be and what the terms of the deal are.

An electronic coupon may merely be an electronic data string (an “EDS”) unique to the user of the WCD 10. The data string may comprise any number of characters in which is contained sufficient information to be able to uniquely indicate the user, indicate the genre/type of the coupon and indicate the basic or threshold value of the coupon. With respect to defining the coupon itself, data items which may be included in the data string may include: coupon source, coupon type, coupon genre and/or product/service category, specific coupon terms such as valid products/services, coupon restrictions and/or exclusions such as valid for weekends but not weekdays, coupon expiration date, coupon pre-requisites such as minimum purchase amount and/or minimum purchase amount in a particular product/service category, discount percentage and/or dollar value of coupon, other offers which are valid with coupon use, other offers which are not valid with coupon use, etc. With respect to identifying the user, data items which may be included in the data string may include: user identifier, user profile identifier, user profile and/or preferences, user affiliations, user history such as past purchases and/or customer prioritization, etc. Where privacy is a concern, some sort of pseudo-identifier may be used in lieu of an actual identity or true identity information as long as uniqueness of identification can be maintained. According to exemplary embodiments, the data string does not have to contain all of the information associated with an electronic coupon but the data string may contain a minimal amount of data sufficient to allow a unique identification to a user and to allow information and formatting data to be retrieved from other data storage devices and displayed to the user. In a very basic example, the EDS may be as simple a three character string, such as ABC where A may uniquely designate the user, B may indicate the specific coupon genre being delivered and C may be the initial or basic value assigned to the electronic coupon. Alternately, C may be omitted if A and/or B can be deterministically referenced to a coupon value, either locally on the WCD 10 or by consulting the central server 40. Or, the coupon may simply be a data string that is a pointer to a set of data in a database or on a web page, whereby the data pointed to contains all the needed information. If a user has been notified on a WCD associated with the user, such as the WCD 10, that a coupon data string has been received and that a determination is made that the user wants to look at the coupon associated with the EDS, the user may select the coupon on the WCD 10. The WCD 10 may then transmit the EDS to the central server 40 and the central server 40 may then download the text, graphics and sound required to render a perceivable version of the coupon associated with the EDS to the user on the WCD 10.

Once the user has perceived the rendition of the coupon on their WCD 10, the user may be persuaded to use the coupon at the nearby vendor location 60/50 that is offering to honor the coupon. The user may peruse the merchandise that is the subject of the coupon offer and may decide to buy. To use the electronic coupon, the WCD 101 may provide the electronic coupon to an intermediary computing device 80/85 that is resident at the vendor location 60/50.

The intermediary computing device(s) 80/85 may be in communication with central server 40 in any manner that is convenient to a designer of the system. Non-limiting examples include communication via the network 90 which may include a POTS, a cellular network, a WiFi connection to another network, a WiMax-enabled connection, the internet, an optical network and the like. The intermediary computing device(s) 80/85 may be any type of computing device. Non-limiting examples may include desk top computers, cash registers, retail or wholesale terminals, PDA's, cell phones, lap top computers, mini-computers and the like.

The WCD 10 may provide the electronic coupon to the intermediary computing device 80/85 by displaying the coupon to a cashier or employee of the vendor location 60/50 who may then enter the coupon data string manually using an input/output device such as a keyboard directly from the rendering of the coupon on the screen 105 of the WCD 10. The coupon may also be scanned from the screen 105 by the intermediary computing device 80 using a bar code reader or other scanning device as may be available. Alternatively, the WCD 10 may transmit the EDS directly to the intermediary computing device 80/85 via local transceiver 107 (See FIG. 2). The local transceiver 107 may employ any suitable short-range communication type including WiFi, WiMax, BlueTooth, UWB (Ultra Wide Band), Zigbee, etc.

Once the EDS is provided to the intermediary communication device 80/85, the vendor's accounts are debited and credited for the purchase and the discount resulting from the electronic coupon. The intermediary computing device 80/85 may down load the electronic coupon terms and conditions from the central server 40 in a similar manner as the WCD 10, discussed above, to effectuate the accounting. During or after the transaction, the intermediary computing device 80/85 notifies the central server 40 of the transaction whereby the central server may record that the coupon has been honored and is no longer negotiable. Such action may temporarily or permanently deactivate the EDS and trigger whatever compensation may have been negotiated by the service provider for the successful servicing of the coupon transaction. Note that some coupons may be used once only, whereas others may remain valid for a time period even regardless of number of uses. Other coupons may be valid for a fixed number of uses, for instance allowing a particular coupon to be used three times before being deactivated.

An electronic coupon may be used to generate higher incremental sales than could be done with a paper coupon by allowing for the combination of electronic coupons in what may be described as consumer promotional contests or games. Users can be offered the opportunity to combine their coupons with those of other users in order to achieve greater savings and/or other added benefit. This may be used to enable a game-like or contest-like aspect in order to make the electronic coupon more fun and exciting, and to inject additional incentive by providing the opportunity for magnified cost savings, in effect providing a way for the user to enlarge the coupon. It may also be used to add a beneficial social aspect, which would be expected to appeal to most users of electronic coupons if appropriately and carefully implemented. For example, the users of the WCDs 10, 20 and 30 may share common interests and buying habits. These propensities may be discernable from respective user preference files 110 associated with each of the WCDs 10, 20 and 30. Users may stipulate preference data that include any number of characteristics. Non-limiting examples of preference data stored in the preference file 110 may include a favorite time of day to shop, vendor, location, merchandise brands and other associated information (e.g., favorite “brand such” as Harry Potter, favorite genres such as Science Fiction, favorite authors such as Isaac Azimov, favorite media such as book or DVD or electronic game, favorite brand of blue jeans, etc.). Even dislikes/exclusions could be included, such as a dislike of war-related movies or a desire to exclude promotions related to video games. Generally, rather than stipulating a comprehensive description of all of their preferences, one might expect that most users might wish to input or select from a list their several most preferred brands or interests as well as a short list of those things which they most want to avoid. The types and combinations of preference data 110 are manifold and can be selected to meet any particular design needs of a user without departing from the scope of the disclosure herein. Data screens may also include estimated time of arrival, directions to the store or other location where the combining is happening, number of users in route to that location, number of like users already at that location, number of users who have already combined their coupons at that location, associated vector analysis and the like. Note that by allowing users to specify their own preference data, they are allowed to both “opt in” to their preferred interest areas as well as to “opt out” of those which they most prefer to avoid. Further, since the coupons are distributed based on preferences, a user can expect to meet other users who have similar interests, thus presenting a beneficial social opportunity to which they may choose to respond.

Because electronic coupons can be targeted in real time to likely buyers with similar preferences, there is a significant probability that the users of the WCDs 10, 20 and 30 may each receive or hold valid electronic coupons of the same genre from the central server 40 simultaneously. That is, multiple customers may hold coupons for the same merchandise, for the same time period and from the same vendor such that it would allow each electronic coupon to be combined with the coupons of others. The genre may be vendor specific and may be defined or limited by the vendor in a multitude of ways. For example, at one extreme, a genre may cover a specific item for a specific time period, at a specific location under limited terms. At another extreme, the genre may cover any merchandise item, in any store of the vendor for an indefinite period of time. A genre may even be presented in terms of general interest areas. Interest area genres may typically be most applicable to beneficial socializing. Product/service genres may typically be most applicable to business and promotional aims. Tradeoffs and fine-tuning may be employed in terms of how preferences are presented in order to achieve the best results. As long as the vendor has defined the genres so as to allow the electronic coupons to be logically combinable from a business standpoint, electronic coupons may be combinable.

Electronic coupons may be combined by appending or concatenating an EDS from the WCD 10, with and EDS of another of the WCDs 20/30. Any number of EDSs (i.e. coupons) may be combined. As a simplified example, the combination of two EDSs may be illustrated as:

| First EDS | | Second EDS | | Combined EDS |
|---|---|---|---|---|
| ABC | + | XYZ | = | ABCXYZ |
| (10$) | | (10$) | | ($25) |

Each electronic coupon (i.e. each EDS) may have a basic value that was assigned to it when the vendor authorized the coupon for issue. However, if desired, combining the EDSs may result in a combined coupon with a value that is greater that the combined original basic value as shown above. This single combined coupon might then be used by both users together, or one user may trade something to the other user and/or pay a certain negotiated dollar amount to the other user to obtain the combined coupon for their exclusive use. Since the coupons were distributed based on user preferences, the users are likely to enjoy shopping for the same sort of products and/or services, and so they may enjoy beneficial social aspects of getting to know each other and shopping together with the combined coupon.

Coupons may also be swapped such that two combined coupons result. For example:

| First EDS | | Second EDS | | Combined EDS |
|---|---|---|---|---|
| ABC | + | XYZ | = | ABCXYZ |
| (10$) | | (10$) | | ($25) |
| Second EDS | | First EDS | | Combined EDS |
| XYZ | + | ABC | = | XYZABC |
| ($10) | | ($10) | | ($25) |

In this case, two coupons result, each having the increased value. Each user can then use their combined coupons separately. Even with separate coupons, they may still shop together and/or socialize if they choose, having been brought together via the coupon combining process.

The values of the user strings may be directly additive (or subtractive) as shown above or they may be multiplicative where the combined value may be more or less than the simple additive value. Further, combining more than two electronic coupons may increase the value at different rates with each succeeding combination depending on the number of coupons combined. An additional data item may be added to a combined EDS which specifies the number of original coupons that have been combined into the composite coupon. The possible mathematical combination of values runs in a continuum and may be established in any number of ways as may satisfy the requirements of a vendor or system provider.

Note that the combining of multiple coupons may occur in one step or in multiple steps. For instance, five users may combine their coupons at one time, whereupon they each receive a coupon with a combination value reflecting five coupons. Subsequently, one of those users may combine her increased coupon with another two users who have not yet combined their coupons, in which case the first user might receive a combined coupon with a value of seven and the two other users might receive combined coupons each with a value of three. Combined coupons received may be in lieu of or in addition to the original coupons. Any suitable set of rules and operations may be used to determine the effects of initial and sequential combining. Also, any set of rules and operations may be used to determine the effects of combining with one, two, three, or more other coupons. Moreover, any set of rules and operations may be used to determine the effects of combining in one, two, three, or more stages. Note that combining coupons alternately or additionally may result in other benefits besides increased value. For instance, coupons may be combined so that the number of times the user can use the coupon is increased and/or the time period for which the coupon is valid is increased and/or the scope of the coupon is increased and/or the number of restrictions/exclusions is reduced. Therefore, “value” as used herein may include any type of benefit including discount, dollar value, number of uses, valid time period, scope or terms, lessened restriction/exclusions, etc.

When provided to the intermediary computing device 80/85, a combined EDS may be processed in the same manner as a single EDS. However, the presence of the combined EDS may trigger an increase in value. When the intermediary computing device 80/85 communicates the combined EDS to the central server 40, the central server may parse the combined EDS to identify each user who has joined in creating the combined EDS. The central server 40 may then analyze the combined coupon to update user preference files 110 and credit each user's account file such as dollar amounts, points, credits and the like.

Coupons may be combined by different means. Coupons could be combined by simply having multiple users, each with an electronic coupon stored on the WCD 10, 20 or 30, approach an employee of the vendor as a group, provide each of the electronic coupons by displaying the coupon on the WCD and request that the EDSs be associated or combined. The association may be accomplished by entering a list of electronic data strings into a Graphical User Interface (“GUI”) executing on the intermediary computing device 80/85 where the intermediary computing device then concatenates or combines the data strings. Alternatively, the central server 40 may receive and automatically associate and process the EDSs to form each combined EDS. Note that combining data strings may be implemented via simply appending data strings, parsing/processing and replacing data strings using various computer engineering methods, or any other suitable means as is well known in the art.

EDSs may also be combined or associated within one or more of the WCD 10, 20, 30. As a non-limiting example, the WCD 10 may transmit its coupon to the WCD 20 and vice versa in an exchange where a combined EDS now exists on each WCD. To the extent that coupons are simply transferable, the WCD 10 may merely transmit the coupon to the WCD 20 where the coupon no longer exists on the WCD 10.

Transmission may be accomplished between the WCDs 10, 20, 30 through the network 90. For example if the WCDs 10 and 20 are cell phones the cell phone 10 may call the cell phone 20. During the call, the users may merely send the coupons over the network 90, as a voice communication, as a data communication, or as a form of text message.

Alternatively, transmission may occur directly between the WCDs 10 and 20. For example, two customers at a book store have received electronic coupons for the latest science fiction thriller. Based on their mutual interest, the users may determine that they each have a coupon and want to combine coupons to get a steeper discount. As such, the users may combine coupons by placing their respective WCDs 10/20 within the proper proximity for transmission and exchange coupons by transmission. As a result, instead of a 10% discount they may each now be entitled to a 25% discount. Because the user of the WCD 10 may want a steeper discount (i.e., the 25% discount of which they have been informed in the promotional offer), the user may meet or know about another user of the WCD 30. The user of the WCD 10 may approach the user of the WCD 30 and suggest combining coupons by the same methods discussed above. The system may be designed and/or the terms of the promotion may be such that only the WCD's 10 10% coupon would be communicated to the WCD 30 (resulting in the 25% coupon) or WCD's 10 newly combined 25% coupon could be transferred to WCD 30 so that at the end of the transfer each WCD would have a 25% off coupon. The possibilities for combining coupons and their values are myriad. One of ordinary skill in the art may recognize a plethora of different combinations to satisfy a particular design requirement.

The information gleaned from the use of the electronic coupons may be used for marketing purposes to other vendors, for marketing purposes by the service provider or for operational purposes. Contests for users may be created based on combining coupons in addition to increasing the value of a coupon. For example, users may receive points from the service provider of the network 90 or a vendor for frequent participation in the coupon game and may win a prize for associating with the largest number of other users.

FIG. 2 depicts a non-limiting example of the WDC 10 and its components. The WCD 10 may include a Radio Frequency (“RF”) transceiver 102 and an associated antenna 103. The transceiver 102 may be capable of communicating wirelessly with the telecommunications network 90.

The WCD 10 may also include the screen 105 and keypad 104. Screen 105 and keypad 104 act as interfaces with the user of the WCD 10. Further, the WCD 10 may include a GPS receiver 106 from which to obtain the current geographical position of the WCD 10. Although the GPS 106 may operate well under good conditions and strong satellite signals, intermittent reception can hinder GPS speed measurements. Therefore, it may be useful to include an additional input to determine a position or a parameter such as speed in order to better ensure a satisfactory level of accuracy when the GPS receiver is impaired or ineffective for any reason. Such additional inputs may include cellular triangulation capability. Further, methods of location determination where the cellular network aids the WCD 10 in its determination of position are well known in the art.

Geographic positions, electronic coupons and EDSs may be saved to a database 109 resident in a memory device 108. The memory device 108 may be comprised of any number or types of memory devices that conform to a manufacturer's requirements. Examples of memory devices include magnetic disks, flash memory, memory sticks, Random Access Memory, and Read Only Memory. The list of memory devices continues to grow over time and any specific examples mentioned herein are not intended to limit the particular device discussed. The memory 108 may contain other varied information and/or instructions such as the set of user preferences 110.

The database 109 of FIG. 2 may be contained in WDC 10 or may be contained within a mass storage device 320 (See FIG. 3) of the central server 40, or both. The central server 40 may be a single server or a collection of distributed servers and mass storage devices. The central server 40 may be located at the central office of a service provider 100. The database 109 may be mirrored within the central database 321 that resides within mass storage device 320. In further embodiments, the database 109 and/or the database 321 may be present as network storage, accessible via the network 90.

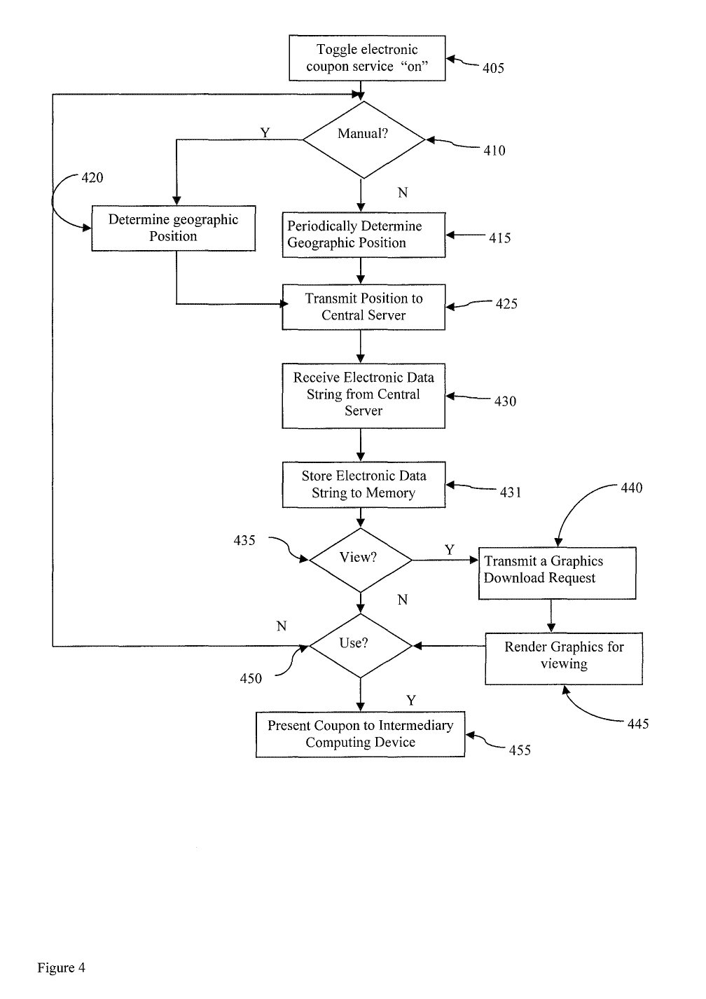

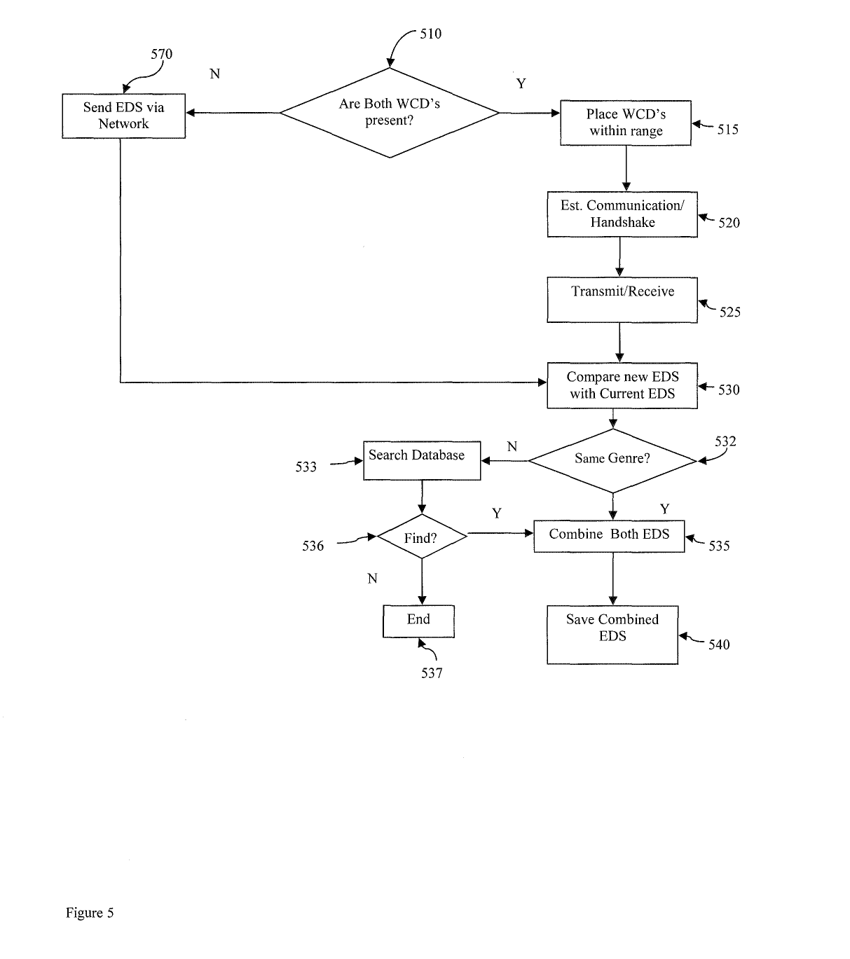

The WCD 10 may have a processor 117 to coordinate the function of its various components. The processor 117 performs actions based on instructions either coded into the processor 117 or stored in the memory 108. An example of the logical operations performed is discussed below in relation to FIGS. 4 and 5. The processor 117 and/or memory 108 are examples of computer readable media which store instructions that when performed implement various logical operations. Such computer readable media may include various storage media including electronic, magnetic, and optical storage. Computer readable media may also include communications media, such as wired and wireless connections used to transfer the instructions or send and receive other data messages.

The processor 117 may include a central processing unit, an embedded processor, a dedicated/specialized processor (e.g. digital signal processor) or a general purpose programmable processor or some combination. The processor 117 may be any other electronic element responsible for interpretation and execution of instructions, performance of calculations and/or execution of voice recognition protocols. Further the processor 117 may communicate with, control and/or work in concert with other functional components, including at least the transceiver 102, the GPS receiver 106, the local transceiver 107 and the database 109. Communications between and among the processor 117, the transceiver 102, the screen 105, the keypad 104, the GPS receiver 106 and other WCD 10 components may be facilitated through a Bus 118. The bus 118 may be comprised of one or a plurality of busses as is desired by a manufacturer.

The local transceiver 107 may communicate via a short range radio format standard. Non-limiting examples of such formats may include Bluetooth®, Ultra-Wideband (UWB), Wireless USB (WUSB), Zigbee, Wi-Fi (IEEE 802.11), WiMAX, WiBro, infrared, near-field magnetics and HiperLAN standards. The local transceiver 107 may also communicate optically using the infrared, ultraviolet, or other spectrum. The local transceiver 107 may also communicate via sound transmission. Further, there may be multiple local transceivers 107 which may communicate via different media including optically, audibly or by radio transmission individually or in combination. The transmission of the data string between WCD 10 and the intermediary computing device 80 may also be a wired interface.

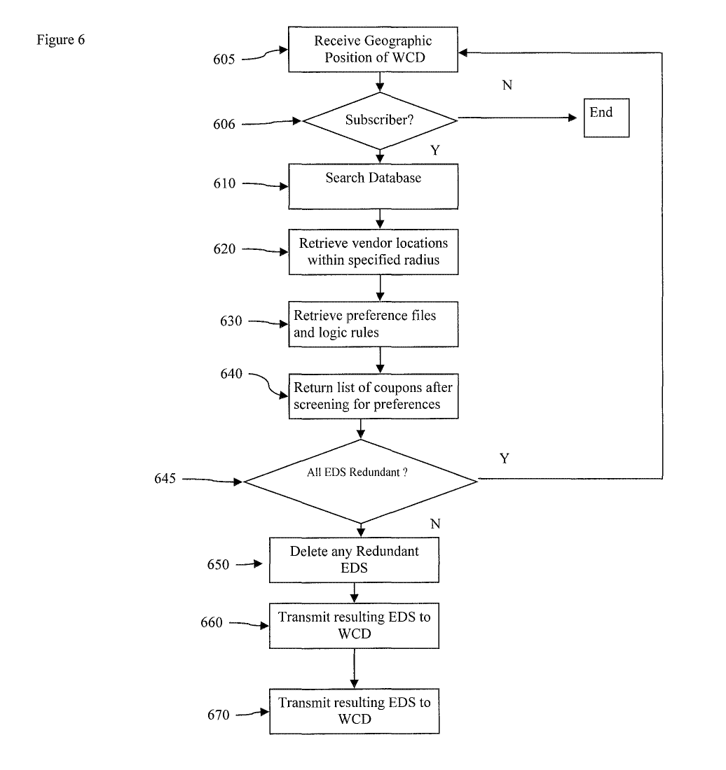

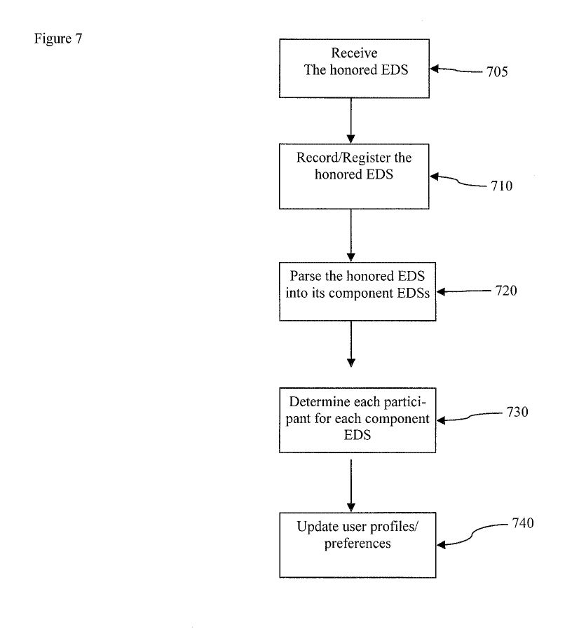

FIG. 3 shows components of an example of the central server 40. The central server 40 may include the standard components of a server computer including a processor 330, memory 340, input/output devices 350, the mass storage 320, and the network interface 310. The processor 330 communicates with external devices including the WCDs 10, 20 and 30 via the network interface 310. The processor 330 may be a single processor, multiple processors or multiple distribute processor and may be a dedicated/special purpose processor or a general purpose programmable processor or some combination. The processor 330 performs actions based on instructions either hard coded into the processor 330 or stored in the memory 340. The processor 330 executes several system functions including receiving geographic position information from reporting users, cross referencing geographic positions with vendor locations, generating electronic coupons, parsing combined EDSs and crediting user and vendor accounts as electronic coupons are generated and honored. Examples of the logical operations performed by the processor are discussed below in relation to FIGS. 6 and 7.

The memory 340 may be volatile or non-volatile or a combination thereof and may store instructions to be performed by the processor 330 when receiving and sending associated information in addition to the user preferences 110 and logic rules 341. As discussed above in relation to the WCD 10, the processor 330 and the memory 340 are examples of computer readable media.

The input/output device 350 may be used for local operation and management of the central server 40. The input/output device 350 may include a keyboard, mouse, display, and the like.

The mass storage device 320 may contain the logic rules 341 and software applications. Non-limiting examples of applications may include an operating system, the electronic coupon service, voice recognition and interactive voice response (“IVR”) systems and an accounting system to track the user's participation and benefits from using the electronic coupon service. Non-limiting examples of user benefits may be cash, points, credits, or merchandise. Thus, the processor 330 may access the storage device 320 when implementing the electronic coupon service. The mass storage device 320 is another example of a computer readable medium and may be a single device or a collection of storage devices disbursed throughout a network.

The user preference module 360 may allow users to access and modify their user profiles either via a web page or via the keypad 104 of WCD 101. If desired, voice recognition and Interactive Voice Response software applications may be used to also communicate with the preference module 360. The user preference response module 360 may be a stand alone hardware component, software object or firmware device and may also be a subcomponent or a composite of any of the other server 40 components such as database 321. The User preference module 360 may also be resident on a remote device or disbursed among several devices.

The vendor module 370 may store information regarding various vendors subscribing to an electronic coupon service. Such information may include any kind of information considered useful to fulfill a specific purpose such as the geographic positions and contact information for the various store locations 50/60 of the various vendors. Other data may include merchandise sold, promotional plans authorized and the like. The vendor module 370 depicted in FIG. 3 is illustrative and may be a stand alone hardware component, software object or firmware device and may also be a subcomponent or a composite of any of the other server 40 components such as database 321. The vendor module 370 may also be resident on a remote device or disbursed among several devices.

The coupon module 380 may be capable of generating, processing and tracking EDSs in response to the server 40 receiving geographic position information from a WCD 101. The coupon module 380 may also process the subsequent use of an electronic coupon when honored at a vendor location. The coupon module 380 may also store text and data elements corresponding to a particular EDS that may generate a perceivable electronic coupon that may be rendered on a user's WCD 101 should the user desire to examine the electronic coupon for use. The coupon module 380 depicted in FIG. 3 is illustrative and may be a stand alone hardware component, software object or firmware device and may also be a subcomponent or an composite of any of the other server 40 components such as database 321. The User preference module 380 may also be resident on a remote device or disbursed among several devices.

FIG. 4 is a flow chart demonstrating an exemplary process of receiving an electronic coupon by a WCD, such as the WCD 10, 20, 30. At process 405, the user selects or toggles “on” a coupon or split coupon game feature via the WCD 10. The WCD 10 checks to see if the user has set a manual or automatic mode at decision point 410. If the WCD 10 has been set to “auto” mode then the WCD 10 begins periodically determining its position at process 415 and auto transmitting its geographic position to the central server 40 at process 425. If set to “manual” mode then the WCD 10 may determine its position when manually prompted by the user at process 420 and transmit its position to the central server 40 at process 425. In the alternative, the WCD 10 may be configured such that the automatic mode is the default mode which may be opportunistically overridden by manipulating a key on keypad 104 or the touch screen 105 such that a single position fix can be transmitted to central server 40 when desired, such as when driving by a “grand opening” event.

If central server 40 determines that there are electronic coupons being offered near the user's position that meet the user's preference criteria 110, then the central server 40 sends an EDS for each such electronic coupon to the WCD 10 at process 430. At process 431, the WDC 10 stores the received EDSs to the memory 108. The user may want to view the electronic coupons to determine if the user wants to use the coupons which can be done at decision point 435. If so, the user may select a coupon and request a text and graphics down load from the central server 40 at process 440. The electronic coupon is rendered at the WCD 10 for viewing at process 445. Should the user of the WCD 10 desire to use the electronic coupon at decision point 450, the WCD 10 may transmit the EDS to the intermediary computing device 80/85 via the local transceiver 107 at process 455. If the user decides not to view the electronic coupon then the coupon merely remains in memory for later recall. If the user views the electronic coupon and does not want to use the coupon then the electronic coupon remains in memory or it may be deleted by the user.

FIG. 5 is a flow chart demonstrating an exemplary process of combining electronic coupons between two WCDs. To combine more than two coupons merely requires repeating the process for each new coupon (i.e. EDS). The user of the WCD 10 may desire to combine or associate one or more coupons associated with the WCD 10 with another user, such as the user of the WCD 30. Should the users decide to combine coupons at decision point 505 then the method of transmission must be decided at decision point 510. If WCDs 10 and 30 are not collocated or proximate with each other, the EDSs may be communicated from one WCD to the other via network 90 in any manner that may occur to one of ordinary skill in the art at process 570. Such communication may be via text messaging, e-mail or instant messaging, for example. From process 570, the process continues to process 530. If the WCDs 10 and 30 are proximate to each other, then the users of each WCD must place his respective WCD within range of the other's local transceiver 107 at process 515. When within range and after communication has been established between the transceivers 107 by handshake or otherwise at process 520, each WCD transmits its respective EDS to the other WCD at process 525. Such transmission may be accomplished automatically upon establishing communications, or the transmission may result from an express command from each user by manipulating a button on the respective keypads 104 or screens 105. Upon receiving the other WCD's 30 EDS, the WCD 10 compares the received EDS with the EDS that was sent to determine if both the EDSs are of the same genre and therefore combinable at process 530. If both EDSs are determined to be of the same genre at decision point 532, then the two EDSs may be combined at process 535 as discussed above. If the genre of the received EDS is not compatible with the one sent, then the WCD 10 the searches the database 109 at process 533 for an EDS of the same genre as the one just received into the memory 108. If a coupon of the same genre can not be found at decision point 536 then the process ends at process 537. Based on the desires of the vendor, the unmatched coupon may then become invalid or it may remain valid and be saved in database 109 for the future use of the user of the WCD 10. If coupons of the same genre are located, then the coupons are combined at process 535. The new, combined EDS is then saved to the database 109 for future use at process 540.

FIG. 6 is a flow chart demonstrating an exemplary process for delivering electronic coupons to the WCD 10, 20, 30. The central server 40 continually scans for incoming geographic position reports for the various WCDs 10, 20 30 within the network 90 that have subscribed and have enabled the electronic coupon service. At process 605, the central server 40 receives a position report from the WCD 10. At process 606, the central server 40 verifies that the WCD 10 is a subscriber to the electronic coupon service. If not, the process ends. If the WCD 10 is a subscribing device then central server 40 searches the database 321 for all vendor locations 50/60 that may exist within a prescribed radius from the reported position at process 610. The prescribed radius may be a user preference provided by the preference file 110 or the prescribed radius may be one of the operational logic rules 341 used by the service provider to optimize system performance.

Upon retrieving a list of participating vendors within the radius at process 620, central server 40 may then retrieve the user preferences 110 for the user of the WCD 10 and the network's 90 logic rules 341 at process 630. The user preferences 110 and the logic rules 341 are used to reduce the list of vendor locations to an optimum list of EDSs (i.e. electronic coupons) at process 630. The resulting list of coupon strings should comply with the vendor's business agreements with the network provider 100 and also provide the user of the WCD 10 with a set of desirable and valuable coupons at process 640. Before transmitting the EDSs to the WCD 10 at process 660, the central server 40 may also ensure that the list does not contain a redundant coupon at process 645. A redundant coupon may be an electronic coupon that has previously been sent to the user of the WCD 10, for example. Redundant coupons take up unnecessary memory capacity and bandwidth as well as probably annoy the user of the WCD 10. If all the selected EDSs are redundant then the process returns to process 605. If a portion or no redundant EDSs are determined, then the central server 40 deletes all redundant electronic coupons at process 650. A process 660, the central server 40 transmits the resulting EDSs to the WCD 10. The central sever 40 may then record to the database 321 which EDSs have been sent to the WCD 10 and then ensure that the EDSs are activated for use at process 670.

FIG. 7 is a flow chart demonstrating an exemplary process for processing electronic coupons. The central server 40 may receive an EDS from the intermediary computing device 80/85 at process 705 after the EDS has been combined and honored during a purchase transaction. However, it should be repeated that EDSs may be combined at the WCD 10 or at the central server 40 as well should a specific purpose require it.

Upon receipt, the central server 40 may record and register the EDS and determine its final value as of the association by the intermediary computing device 80/85 at process 710. Registration may include determining various data which may include the vendor, the date honored, the location in which the transaction took place and the final value of the EDS as non-limiting examples. If the EDS is uncombined then the value may be the original value. If combined then the value may be different than the original value and/or some other type of benefit may be added or increased. As the disclosure herein contains some aspects of a game or competition, the effect of combining or merely using the electronic coupon may also result in a detriment to the user such as a decrease in value or other penalty.

The central server 40 may then update the vendor's records at process 712. A vendor record may include a variety of data including the number and genre of coupons issued and the number honored. The record may be updated to record the merchandise sold, the number of units, the purchaser's identity and/or the category/profile of the purchaser, the final price and the discount. The record may include any financial accounting data associated with the service provider's contract with the vendor. Any type of data associated with an electronic coupon vendor may be part of a vendor record and updated accordingly.

At process 720, the central server 40 may then parse the combined electronic data string. If the combined electronic data string is a single, uncombined string then the parsing is essentially a trivial matter and the process may continue. The central server 40 determines each participating user in the combined coupon by breaking down the combined data string into the component EDSs that are unique to each participant at process 730. Each user profile/preference record is then updated to reflect the use of the combined coupon or data string at process 740. The central server may record what was purchased, how much was purchased, when it was purchased and where it was purchased. Other data that may be of interest may also be captured and updated. Further, if the user was competing in any contests for prizes, such as being the user that could associate the most other electronic coupons to their own, their records would be updated to reflect those changes as well.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for provisioning and using an electronic coupon, comprising:
receiving an electronic file at a mobile communication device from a server via a network based at least in part upon a current geographic position of the mobile communication device, wherein the electronic file identifies a location and includes a data string unique to a user of the mobile communication device; and
providing the electronic file to an intermediary computing device associated with the location.

2. The method of claim 1, further comprising associating the data string with the location of the intermediary computing device by the intermediary computing device.

3. The method of claim 1, wherein providing the electronic file to an intermediary computing device includes one of displaying the electronic file to an operator of the intermediary computing device for input into the intermediary computing device via an input/output device and transmitting the electronic file to the intermediary computing device.

4. The method of claim 1, further comprising:
displaying the electronic file to a user of the mobile communication device via a user interface.

5. The method of claim 1, further comprising:
periodically transmitting the current geographic position of the mobile communication device to the server, wherein the server:
determines a list of locations existing within a designated distance from the current geographic position; and
selects the location from the list of locations at least partly based on a preference profile of the user of the mobile communication device.

6. The method of claim 1, wherein at least part of the data string represents a value and a genre, wherein the genre permits the data string value to be modified by other data strings of the same genre.

7. The method of claim 6, wherein the value represented by the data string is modified by combining the data string with a data string unique to a user of another mobile communication device.

8. The method of claim 7, wherein the mobile communication device combines the data string after receiving a transmission of a data string of the same genre and unique to a user of another mobile communication device.

9. A server within a network for provisioning and using an electronic coupon, comprising:
a network interface; and
a processor that sends and receives data via the network interface, the processor receiving geographic data from a wireless communication device and subsequently returning an electronic data string to the wireless communication device, wherein the geographic data includes a current geographic position of the wireless communication device and the electronic data string is unique to a user of the wireless communication device and is also associated with a vendor location.

10. The server of claim 9, wherein the server further comprises:
a user preference module, wherein the user of the wireless communication device maintains a user preference file;
a vendor information module, wherein a plurality of vendor records are maintained; and
a coupon module, wherein the electronic data string is generated in accordance with the user preference file, the vendor location records and the current geographic position of the wireless communication device.

11. The server of claim 10, wherein the vendor information module compiles a list of vendor locations that exist within a specified distance from the current geographic position of the wireless communication device.

12. The server of claim 9, wherein the processor screens for and deletes all redundant electronic data strings generated by the coupon module.

13. The system of claim 12, wherein the electronic data string further indicates an assigned value and a genre.

14. A wireless communication device communicating within a network for the provision and use of an electronic coupon file, comprising:
a transceiver;
a position determination means; and
a processor that sends geographic data to a server within the network via the transceiver and receives the electronic coupon file in response, the processor receiving the geographic data from the position determination means, wherein the geographic data includes a current geographic position of the wireless communication device and the electronic coupon file includes a data string unique to a user of the wireless communication device and also associated with a vendor location.

15. The device of claim 14, wherein the device provides the electronic coupon file to an intermediary computing device.

16. The device of claim 15, wherein the device provides the electronic coupon file to the intermediary computing device by one of an manual input/output device and transmission of the electronic file.

17. The device of claim 16, wherein transmitting the electronic coupon file to the intermediary computing device is accomplished by at least one of a radio transmission, a sonic transmission and a light transmission.

18. The device of claim 14, wherein the electronic coupon file comprises an assigned value and a genre.

19. The system of claim 18, wherein the assigned value of an electronic coupon file is modified when electronically combined with an electronic coupon file of the same genre unique to a user of a second mobile communication device.

20. The system of claim 19, wherein the electronic coupon file and the electronic coupon file unique to the second communication device are combined in the first mobile communication device after the first mobile communication device receives a transmission of the electronic coupon file of the same genre unique to a user of a second mobile communication device.
